(19) United States
(12) Patent Application Publication
(10) Pub. No.: US 2024/0174886 A1
(43) Pub. Date: May 30, 2024

(54) ELASTOMERIC POLYMER COMPOSITIONS AND RAIL TRACK STRUCTURES AND SYSTEMS COMPRISING THE SAME

(71) Applicants: EQUUS UK TOPCO LTD, Weybridge, Surrey (GB); EDILON) (SEDRA B.V., Haarlem (NL); STICHTING WAGENINGEN RESEARCH, Wageningen (NL)

(72) Inventors: Wilhelmus Jacobus Adrianus HONCOOP, Weybridge, Surrey (GB); Gerrit Marinus VAN DER HOUWEN, Haarlem (NL); Pieter Joost KERKHOVEN, Haarlem (NL); Stefanus Jacobus Maria KOTERIS, Haarlem (NL); Willem VOGELZANG, Wageningen (NL); Johannes Rutger Idsard KNOOP, Wageningen (NL); Roelf BLAAUW, Wageningen (NL)

(73) Assignees: EQUUS UK TOPCO LTD, Weybridge, Surrey, EN (GB); EDILON) (SEDRA B.V., Haarlem (NL); STICHTING WAGENINGEN RESEARCH, Wageningen (NL)

(21) Appl. No.: 18/551,965

(22) PCT Filed: Mar. 24, 2022
(86) PCT No.: PCT/EP2022/057755

§ 371 Date: Sep. 22, 2023

(30) Foreign Application Priority Data
Mar. 24, 2021 (GB) 2104089.4

(51) Int. Cl. C09D 153/00; C08F 299/06; E01B 19/00

(52) U.S. Cl. CPC C09D 153/00; C08F 299/06; E01B 19/00

(57) ABSTRACT

The present invention relates to elastomeric polymer compositions comprising an acrylate and the reaction product of an acetoacetylating agent and a polyol. In particular, such elastomeric polymer compositions can be used in railway track structures. The invention also relates to a method for applying the elastomeric polymer composition in railway track structures, in particular, the method of applying the polymer composition may advantageously utilise a C-Michael addition reaction which is facilitated by the reaction product of an acetoacetylating agent and a polyol present in the polymer. The invention further relates to railway track structures and systems comprising the elastomeric polymer compositions.

The present invention relates to elastomeric polymer compositions comprising an acrylate and the reaction product of an acetoacetylating agent and a polyol, in particular such elastomeric polymer compositions can be used in railway track structures. The invention also relates to a method for applying the elastomeric polymer compositions in railway track structures. The invention further relates to railway track structures comprising the elastomeric polymer composition according to the invention. In some embodiments, the invention also relates to said elastomeric polymer compositions formed into foam sheets for supporting concrete slabs with fastened rail in railway track structures.

The manufacture of polyurethanes involves the reaction of polyols and isocyanates. In the manufacture of polyurethanes, the polyurethane is supplied as a two-component composition, wherein the isocyanates on the one hand, and the polyols on the other hand, are provided in separately packed containers or kits, to be mixed together moments before application of the composition. Such free monomeric isocyanates pose limitations when considering safety, environmental and health factors. Especially the toxicological profiles of monomeric isocyanates in the poly-isocyanate hardeners present in such polyurethanes have come under recent scrutiny, and changes driven by legislation have lead the polyurethane manufacturing industry to search for new polymers, particularly ones which do not require the presence of isocyanate during manufacturing the polyurethane components, and especially during application of the polyurethane composition, but where the performance of the polymer for its intended end use is not compromised.

A further disadvantage of isocyanate based polyurethanes is that they release hydrogen cyanide in case of fire or when rails are welded or cut. Hydrogen cyanide is extremely toxic. Moreover, polyurethanes are petroleum based, and as such are not sustainable, which poses further environmental issues.

As such, new technologies are sought to produce polymers which provide beneficial polyurethane mechanical and chemical properties, but without using isocyanates. Such new technologies would be considered more sustainable.

It is known that railway track structures can be embedded in a polymer composition to dampen vibration and noise. Polyurethane compounds are known to provide satisfactory noise- and vibration-dampening properties. For example, patent application DE 19627468 discloses a rail installation method in which a two-part polyurethane reaction mixture is introduced into the space enclosed by the formwork. The polyurethane reaction mixture is introduced under the rail and on both sides of the rail, such that, after the reaction process has taken place the rail is smoothly embedded in the resulting polyurethane elastomer. This resulting polyurethane elastomer provides vibration insulation during use of the railway track structure.

In railway track applications, the workers that apply the polyurethane compositions to the railway track structures have to mix both components of the polyurethane polymer and apply the polymer composition. The railway workers are thus exposed to reactive isocyanate monomers. Additionally, isocyanate based polyurethanes utilised in railway track structures may release hydrogen cyanide in case of fire or when rails are welded or cut during track installation, removal, or repair, posing a health risk to members of the public and railway workers.

Besides use in the embedding of rails, polyurethane polymers are also used in a wide variety of other forms found in railway track structures, for example as non-cellular materials such as elastomers, and cellular materials such as low density flexible foams, high density flexible foams, and microcellular foams. Such foams may be provided as support mats or pads for supporting concrete slabs with fastened rail in railway track structures. These foam mats or pads may also provide vibration damping.

Michael addition (or Michael reaction) chemistry is believed to offer an alternative sustainable process by which useful polymers could be prepared in the absence of isocyanate. Michael addition chemistry has been researched and used in some applications (Noomen, A., Prog. Org. Coat, 32, 137-142 (1997)).

The key chemical components of a Michael addition system are electron deficient C═C double bonds, acidic C—H bonds and a base catalyst strong enough to abstract the proton of one of the C—H bonds which provides a nucleophilic carbanion that can add to the C═C double bond. A carbon-carbon link is thus formed between the two molecules via reaction of the nucleophilic carbanion provided. The second proton of the donor molecule is available for a similar, subsequent, reaction.

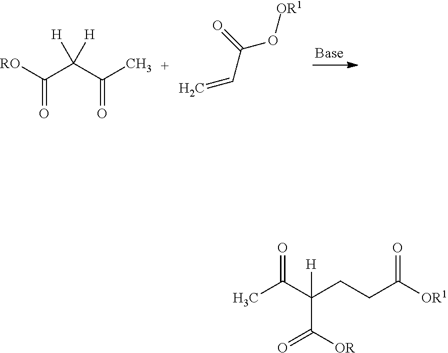

The present invention seeks to provide a polymer composition, notably an elastomeric polymer composition to be used in railway track structures such as in the fastening, fixation or embedding of rail track in concrete, asphalt, or other road surfaces, or to be used in foam sheets that are suitable for supporting concrete slabs with fastened rail track so that the problems associated with isocyanate derived polyurethanes in this field can be overcome.

Surprisingly, it has been found that Michael addition chemistry can be used in preparation of polymers suitable for use in railway track structures, thereby overcoming the disadvantages of polyurethane chemistry based on reaction of polyols and isocyanates.

It will be understood that any upper or lower quantity or range limit stated herein may be independently combined.

It will be understood by the skilled person that, when describing the number of carbon atoms in a substituent group (e.g. ‘C1 to C6’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branched groups.

Many of the chemicals which may be used to produce the polyol or polymer composition of the present invention are obtained from natural sources. Such chemicals typically include a mixture of chemical species due to their natural origin. Due to the presence of such mixtures, various parameters defined herein can be an average value and may be non-integral.

The term ‘polyol’ is well known in the art and refers to a molecule comprising more than one hydroxyl group.

The term ‘polyester’ as used herein refers to a molecule or group with more than one ester bond.

The term ‘dimer fatty residue’ as used herein, unless otherwise defined, refers to a residue of a dimer fatty acid (also referred to as a dimer fatty diacid) or a residue of a dimer fatty acid derivative such as a dimer fatty diol or a dimer fatty diamine.

The term ‘functionality’ as used herein with regard to a molecule or part of a molecule refers to the number of functional groups in that molecule or part of a molecule. A ‘functional group’ refers to a group in a molecule which may take part in a chemical reaction. For example, a carboxylic acid group, a hydroxyl group and an amine group are all examples of functional groups. For example, a diacid (with two carboxylic acid groups) and a diol (with two hydroxyl groups) both have a functionality of 2 and a triacid and triol both have a functionality of 3.

The term ‘dimer fatty acid’ (also referred to as dimer fatty diacid) is well known in the art and refers to the dimerisation products of mono- or polyunsaturated fatty acids and/or esters thereof. The related term trimer fatty acid similarly refers to trimerisation products of mono- or polyunsaturated fatty acids and/or esters thereof.

A railway track system is understood to be any track structure comprising a rail which enables carts such as trains, trams, metros, but also other transporting means such as dock cranes, etc. to move by providing a dependable surface for their wheels to roll upon.

A railway track structure is understood to be any subunit of a railway track system. For example, a railway track system could be a tramway formed by a number of railway track structures pre-formed off site and affixed together to create the overall system track.

A railway track structure component is understood to be any individual part or constituent of a railway track structure or system. Examples of railway track structure components may include road surfaces such as concrete or asphalt, a rail, a rail foot, concrete blocks, rail connecting means, railroad ties (sleepers), ballast or non-ballasted track (slab track), etc. However, the term railway track structure component is not meant to be limited to these specific examples.

The terms “elastic”, “elastomer” and “elastomeric” maybe used interchangeably to refer to the polymer composition of the present invention.

In accordance with one embodiment of the present invention there is provided an elastomeric polymer composition comprising an acrylate and the reaction product of an acetoacetylating agent and a polyol and wherein the polyol comprises:
a) at least one dimer fatty residue selected from a dimer fatty acid residue, a dimer fatty diol residue and a dimer fatty diamine residue: and
b) at least one residue of a linear or branched C2 to C36 diacid or diol.

Furthermore, there is provided a method of applying the elastomeric polymer composition in a railway track structure comprising the steps of:
i) Preparing a polymer composition mixture by mixing
   A) the reaction product of said acetoacetylating agent and said polyol, and
   B) the acrylate;
ii) applying the polymer composition mixture to at least one or more railway track structure component; and
iii) allowing the polymer composition mixture to cure.

In particular, there is also provided a railway track structure comprising such an elastomeric polymer composition, or obtainable via a method for applying a polymer composition, as described herein. Such a railway track structure may comprise a foam sheet, base plate, fastening, tray, body, or other component, formed from the described elastomeric polymer composition.

Furthermore, there is provided use of the elastomeric polymer composition, which is optionally obtainable via a method for applying a polymer composition, in a railway track structure or system, in particular for the fastening or the embedding of rail components.

The present invention provides an elastomeric polymer composition comprising an acrylate and the reaction product of an acetoacetylating agent and a polyol and wherein the polyol comprises:
a) at least one dimer fatty residue selected from a dimer fatty acid residue, a dimer fatty diol residue and a dimer fatty diamine residue: and
b) at least one residue of a linear or branched C2 to C36 diacid or diol.

More especially, the elastomeric polymer composition is the reaction product of the acrylate and the reaction product (i.e. prior formed product) of said acetoacetylating agent and said polyol. Such elastomer polymer compositions may have one or more desired physical properties and be particularly suited to their intended end use in railway track structures and systems.

Suitably, the elastomeric polymer composition may be a resin (i.e. a pre-cure mixture) or a polymer matrix (i.e. a post-cure polymeric material in its final form). As such, the elastomeric polymer composition can be considered to embrace two distinct embodiments, the first being a resin and the second being a polymer matrix. There is a large amount of overlap between the two elastomeric polymer composition embodiments since additives necessary for intended use or processing of a polymer matrix final product may be introduced during manufacture of the polymer resin for ease of post-processing or handling. As such, embodiments below which refer to the “polymer composition” may apply equally to the polymer resin and polymer matrix embodiments.

The elastomeric polymer composition may be provided as a resin, and subsequently the resin may be converted to an elastomeric polymer matrix via curing. The difference between the polymer resin and polymer matrix, as will be appreciated by the skilled person, is that cross-linking of the polymer chains will be present in the polymer matrix.

The elastomeric polymer composition is preferably derived from renewable and/or bio-based sources. Preferably, the polymer composition has a renewable carbon content of at least 50%, more preferably at least 65% and most preferably at least 80% as determined using ASTM D6866. ASTM D6866 providing Standard Test Methods for Determining the Biobased Content of Solid, Liquid, and Gaseous Samples Using Radiocarbon Analysis.

It is a particular advantage of the elastomeric polymer composition of the present invention that it is isocyanate free. As such, the polymer composition does not contain isocyanate, and preferably the polymer composition is substantially free from isocyanate.

Suitably, the molar ratio of the reaction product of an acetoacetylating agent and a polyol to acrylate is in the range from between 1:0.2 to 1:4, preferably from between 1:0.25 to 1:3, more preferably from between 1:0.25 to 1:2.5, and most preferably from between 1:0.25 to 1:1.8.

The elastomeric polymer composition comprises the reaction product of an acetoacetylating agent and a polyol and wherein the polyol comprises:
a) at least one dimer fatty residue selected from a dimer fatty acid residue, a dimer fatty diol residue and a dimer fatty diamine residue; and
b) at least one residue of a linear or branched C2 to C36 diacid or diol.

The reaction product of the acetoacetylating agent and the polyol may have a molecular weight (number average) of at least 500 g/mol, preferably at least 800, more preferably at least 1000, even more preferably at least 1500, especially preferably at least 1800 g/mol.

The reaction product of the acetoacetylating agent and the polyol may have a molecular weight (number average) of at most 5000 g/mol, preferably at most 4000, more preferably at most 3000, even more preferably at most 2500, especially preferably at most 2200 g/mol.

In addition, the reaction product of the acetoacetylating agent and the polyol may have an acid value (measured as described herein) of less than 2, more preferably less than 1.7, particularly preferably less than 1.3, and especially preferably less than 1.0 mgKOH/g.

The acetoacetylating agent may be selected from one or more of the following: methyl acetoacetate, ethyl acetoacetate, tert-butyl acetoacetate, isopropyl acetoacetate, and isobutyl acetoacetate. Preferably the acetoacetylating agent is tert-butyl acetoacetate.

The reaction product of the acetoacetylating agent and the polyol may comprise at most 10 wt % acetoacetylating agent, preferably at most 5 wt %, more preferably less than 5 wt % acetoacetylating agent.

Suitably, in the reaction product of the acetoacetylating agent and the polyol, the polyol functional hydroxyl groups may have a conversion rate up to 100%, such that all of the hydroxyl groups of the polyol are reacted. However, in some embodiments a lower conversion rate of the polyol functional hydroxyl groups may be desirable, and as such it is preferred that for the reaction product of the acetoacetylating agent and the polyol, the polyol functional hydroxyl groups may have a conversion rate of between 50% and 100%, more preferably between 65% and 100%, and most preferably between 75% and 100%.

The polyol of the reaction product of the acetoacetylating agent and the polyol will now be described in more detail.

Necessarily the polyol comprises at least more than one functional hydroxyl groups. Suitably, the polyol may be a diol, triol, tetrol, pentol or hexol. Preferably the polyol is a diol, triol or tetrol, and more preferably a diol or triol. Most preferably, the polyol is a diol. Suitably, the polyol is a diol, and the two functional hydroxyl groups present on the diol react with the acetoacetylating agent to form said reaction product of the acetoacetylating agent and the polyol. Where a higher functional polyol is utilised, at least two hydroxyl functional groups react with the acetoacetylating agent to form said reaction product, but in this case some unreacted hydroxyl functional groups may remain present in the reaction product.

The polyol may comprise at least 2 ester bonds, preferably at least 3 ester bonds, more preferably at least 4 ester bonds, even more preferably at least 5 ester bonds.

The polyol may comprise at most 10 ester bonds, preferably at most 8 ester bonds, more preferably at most 7 ester bonds.

The polyol may be a polyester.

The polyol may comprise at least one ether bond. The polyol may be a polyester ether. Alternatively, the polyol may not comprise an ether bond.

In a less preferred embodiment the polyol may comprise at least one amide bond.

Alternatively, the polyol may not comprise an amide bond.

In a less preferred embodiment the polyol may be a polyester amide. The polyol may not be a polyester amide.

The polyol preferably has a hydroxyl value (measured as described herein) in the range from 100 to 250, more preferably 125 to 225, particularly preferably 150 to 200, and especially preferably 160 to 180 mgKOH/g.

The weight ratio of a) to b) in the polyol may be in the range 90:10 to 30:70, preferably in the range 85:15 to 45:55. The weight % of a) in the polyol may be at least the weight % of b). These relative amounts of a) and b) in the polyol may provide an advantageous balance of flexibility, tensile strength, hardness and hydrolysis resistance in a polymer matrix comprising the reaction product of the acetoacetylating agent and the polyol, as further described below.

The polyol comprises,
a) at least one dimer fatty residue selected from a dimer fatty acid residue, a dimer fatty diol residue and a dimer fatty diamine residue,
   and this will now be described in more detail.

Generally, the at least one dimer fatty residue may include any of the features or preferences described herein with regard to dimer fatty acids, dimer fatty diols or dimer fatty diamines as detailed below.

The dimer fatty residue content of the elastomeric polymer composition is preferably in the range from 5 to 60%, more preferably 8 to 55%, particularly 15 to 50%, and especially 20 to 45% by weight.

The polyol may comprise at most 80 wt % dimer fatty residue, preferably 75 wt % dimer fatty residue, and more preferably at most 70 wt %. The reaction product of the acetoacetylating agent and the polyol may comprise at least 5 wt % dimer fatty residue, preferably at least 10 wt %.

Suitably, the at least one dimer fatty residue may be saturated or unsaturated. However, preferably the at least one dimer fatty residue is saturated.

The dimer fatty residue is fatty in nature and this may increase the hydrophobicity of the polyol. The presence of the dimer fatty residue may render the polyol more amorphous, non-crystalline or substantially non-crystalline. The amorphous nature of the polyol may increase the flexibility and/or decrease the tensile strength of a polymer matrix comprising the polyol, as further described below.

The at least one dimer fatty residue selected may be a dimer fatty acid residue.

Dimer fatty acids are described in T. E. Breuer, ‘Dimer Acids’, in J. I. Kroschwitz (ed.), Kirk-Othmer Encyclopaedia of Chemical Technology, 4th Ed., Wily, New York, 1993, Vol. 8, pp. 223-237. They are prepared by polymerising fatty acids under pressure, and then removing most of the unreacted fatty acid starting materials by distillation. The final product usually contains some small amounts of mono fatty acid and trimer fatty acids but is mostly made up of dimer fatty acids. The resultant product can be prepared with various proportions of the different fatty acids as desired.

Suitably, the reaction product of the acetoacetylating agent and the polyol may comprise at least 5 wt % dimer fatty acid residue, preferably at least 10 wt %. The polyol may comprise at 35 most 95 wt % dimer fatty acid residue, preferably at most 90 wt %, more preferably at most 80 wt %.

The ratio of dimer fatty acids to trimer fatty acids can be varied, as is known to the person skilled in the art, by modifying the processing conditions and/or the unsaturated fatty acid feedstock. The dimer fatty acid may be isolated in substantially pure form from the product mixture, using purification techniques known in the art, or alternatively a mixture of dimer fatty acid and trimer fatty acid may be employed.

The dimer fatty acids or dimer fatty residues used in the present invention are preferably derived from the dimerisation products of C10 to C30 fatty acids, more preferably C12 to C24 fatty acids, particularly C14 to C22 fatty acids, further preferably C16 to C20 fatty acids, and especially C18 fatty acids. Thus, the resulting dimer fatty acids preferably comprise in the range from 20 to 60, more preferably 24 to 48, particularly 28 to 44, further preferably 32 to 40, and especially 36 carbon atoms.

Suitably, the fatty acids, from which the dimer fatty acids are derived, may be selected from linear or branched unsaturated fatty acids, and linear fatty acids are preferred. The unsaturated fatty acids may be selected from fatty acids having either a cis/trans configuration and may have one or more than one unsaturated double bond. However, monounsaturated fatty acids are particularly preferred. Most preferably, the fatty acids are linear monounsaturated fatty acids.

Suitably, the dimer fatty acids may be non-hydrogenated, hydrogenated, or partially hydrogenated. A hydrogenated dimer fatty residue (whether from a diacid, diol or diamine) may have better oxidative or thermal stability which may be desirable in a polymer comprising the polyol, as such preferably the dimer fatty acid is hydrogenated or partially hydrogenated.

Suitable dimer fatty acids are preferably derived from (i.e. are the dimer equivalents of) the dimerisation products of oleic acid, linoleic acid, linolenic acid, palmitoleic acid, or elaidic acid. In particular, suitable dimer fatty acids are preferably derived from oleic acid.

The dimer fatty acids may be dimerisation products of unsaturated fatty acid mixtures obtained from the hydrolysis of natural fats and oils, e.g. sunflower oil, soybean oil, olive oil, rapeseed oil, cottonseed oil, or tall oil.

The molecular weight (weight average) of the dimer fatty acid is preferably in the range from 450 to 690, more preferably 500 to 640, particularly 530 to 610, and especially 550 to 590.

Furthermore, in addition to the dimer fatty acids, dimerisation usually results in varying amounts of trimer fatty acids (so-called “trimer”), oligomeric fatty acids, and residues of monomeric fatty acids (so-called “monomer”), or esters thereof, being present. The amount of monomer can, for example, be reduced by distillation. Since distillation of the dimer fatty acid product will increase production costs the presence of these optional dimerisation reaction products is tolerated, however, purification by distillation of the dimer fatty acid may be preferred for some niche applications.

Suitably, the trimer fatty acids are preferably derived from the trimerisation products of the materials mentioned with regard to the dimer fatty acids, and are preferably trimers of C10 to C30, more preferably C12 to C24, particularly C14 to C22, further preferably C16 to C20 fatty acids, and especially C18 fatty acids. Thus, the trimer fatty acids preferably contain in the range from 30 to 90, more preferably 36 to 72, particularly 42 to 66, further preferably 48 to 60, and especially 54 carbon atoms.

The molecular weight (weight average) of the trimer fatty acids is preferably in the range from 750 to 950 g/mol, more preferably 790 to 910, particularly 810 to 890, and especially 830 to 870 g/mol.

Additionally, or alternatively, tetramer fatty acids and higher oligomers (hereinafter both referred to as oligomeric acids) may be formed during production of the dimer fatty acid. Such oligomeric acids may therefore also be present in the dimer fatty acids used in the present invention, in combination with trimer fatty acids and/or dimer fatty acids and/or mono fatty monoacids, as alluded to above.

The oligomeric acids are preferably oligomers, containing 4 or more units derived from 010 to C30, more preferably C12 to C24, particularly C14 to C22, and especially C18 fatty acids. The molecular weight (weight average) of the oligomeric acid is suitably greater than 1000 g/mol, preferably in the range from 1200 to 1800, more preferably 1300 to 1700, particularly 1400 to 1600, and especially 1400 to 1550 g/mol.

The dimer fatty acid used in the present invention preferably may have a dimer fatty acid (or dimer) content of greater than 60 wt %, more preferably greater than 70 wt %, particularly greater than 80 wt %, and especially greater than 85 wt %. Most preferably, the dimer content of the dimer fatty acid is in the range from 90 wt % to 99 wt %.

In an alternative embodiment, the dimer fatty acid preferably has a dimer fatty acid (or dimer) content in the range from 70 wt % to 96 wt %. This may be applicable in particular for two component or cross-linked systems.

Additionally, or alternatively, particularly preferred dimer fatty acids may have a trimer fatty acid (or trimer) content of less than 40 wt %, more preferably less than 30 wt %, particularly less than 20 wt %, and especially less than 15 wt %. The trimer fatty acid content may be less than 4 wt %.

Furthermore, the dimer fatty acid preferably comprises less than 10 wt %, more preferably less than 5 wt %, particularly less than 4 wt %, and especially less than 2.5 wt % of mono fatty monoacid (or monomer).

All of the above weight percentage values are based on the total weight of the polymerised fatty acids and mono fatty acids present in the dimer fatty acid.

The at least one dimer fatty residue selected may be a dimer fatty diol residue.

A suitable dimer fatty diol may be formed by hydrogenation of the corresponding dimer fatty acid. A dimer fatty acid (or dimer fatty diacid) may be converted to a dimer fatty diol as is known in the art. A dimer fatty diol may have properties as described herein with regard to a dimer fatty acid (or dimer fatty diacid) except that the acid groups in the dimer fatty acid are replaced with hydroxyl groups in the dimer fatty diol. In a similar manner, a trimer fatty triacid may be converted to a trimer fatty triol which may have properties as described herein with regard to a trimer fatty triacid. As such, the same preferred embodiments detailed herein in relation to the dimer fatty acid may apply to corresponding preferred embodiments of the dimer fatty diol residue component of the polyol.

Suitably, the polyol may comprise at least 50 wt % dimer fatty diol residue, preferably at least 60 wt %. The polyol may comprise at most 90 wt % dimer fatty diol residue, preferably at most 80 wt %. These amounts of dimer fatty residue may provide a suitable amount of hydrophobicity and/or amorphousness to the polyol without an excessive decrease in tensile strength or hardness of a polymer matrix comprising the polyol.

Suitably, the reaction product of the acetoacetylating agent and the polyol may comprise at least 5 wt % dimer fatty diol residue, preferably at least 10 wt %. The polyol may comprise at most 30 wt % dimer fatty diol residue, preferably at most 20 wt %.

The dimer fatty diol may be hydrogenated. The dimer fatty diol may be non-hydrogenated.

Additionally, or alternatively, the polyol may comprise at least one dimer fatty diamine residue, such that the at least one dimer fatty residue selected may be a dimer fatty diamine residue. However, this embodiment is less preferred, and the polyol may comprise no dimer fatty diamine residue, and hence no associated amine groups in component a) of the polyol.

The polyol comprises,
b) at least one residue of a linear or branched C2 to C36 diacid or diol, and this will now be described in more detail.

Preferably the at least one residue of a C2 to C36 diacid or diol has at least two functional groups selected from a carboxylic acid group, a hydroxyl group, and mixtures thereof.

In some embodiments, the diacid or diol preferably has two functional groups selected from a carboxylic acid group, a hydroxyl group, and mixtures thereof.

The polyol may comprise at least 10 wt % of component b), preferably at least 15 wt %, more preferably at least 20 wt %. The polyol may comprise at most 50 wt % of b), preferably at most 40 wt %. The reaction product of the acetoacetylating agent and the polyol may comprise at least 0.10 wt %, preferably at least 0.15 wt %, and more preferably at least 0.20 wt % of b). Furthermore, the reaction product of the acetoacetylating agent and the polyol may comprise at most 15 wt % dimer fatty diol residue, preferably at most 8 wt %. These amounts of b) may provide a suitable amount of crystallinity to the polyol without an excessive decrease in flexibility of a polymer matrix comprising the reaction product of the acetoacetylating agent and the polyol.

It should be understood that component b) is a non-dimeric diacid or diol and is distinct to the dimer fatty acid and diols described above for component a).

Suitable non-dimeric diacids may be aliphatic or aromatic (such as phthalic acid, isophthalic acid and terephthalic acid), and include dicarboxylic acids and their esters, preferably alkyl esters, thereof.

Preferably the polyol comprises at least two residues of a linear or branched C2 to C36 diacid or diol, and in some embodiments may comprise at least three residues of a linear or branched C2 to C36 diacid or diol, each independently selected from the preferred embodiments detailed below. The inclusion of more than one type of one residue of a linear or branched C2 to C36 diacid or diol will allow the physical properties of a polymer comprising the reaction product of the acetoacetylating agent and the polyol to be tailored to its specific end use.

In one particularly preferred embodiment b) comprises at least one residue of a linear or branched C6 to C36 dicarboxylic acid or diol. The presence of b) in the polyol may make the polyol more crystalline due to the long aliphatic carbon chain present in the at least one residue of a C6 to C36 linear or branched dicarboxylic acid or diol. The increased crystallinity may increase the tensile strength and/or hardness of a polymer matrix comprising the reaction product of the acetoacetylating agent and the polyol. The at least one residue of a C6 to C36 linear or branched diacid may include the esters thereof, preferably alkyl esters and more preferably dimethyl esters.

The at least one residue of a C6 to C36 linear or branched dicarboxylic acid or diol may be linear. It may comprise terminal carboxyl or hydroxyl groups, wherein the terminal carboxyl or hydroxyl groups are bridged by an alkyl group, or an alkenyl group.

The at least one residue of a C6 to C36 linear or branched dicarboxylic acid or diol may be branched. The at least one residue of a C6 to C36 linear or branched diacid or diol may comprise at least one methyl branch. The at least one residue of a C6 to C36 linear or branched diacid or diol may comprise at least one ethyl branch.

The at least one residue of a C6 to C36 linear or branched dicarboxylic acid or diol may be saturated or unsaturated, preferably saturated.

Preferably the C6 to C36 dicarboxylic acid or diol is a linear dicarboxylic acid.

The C6 to C36 dicarboxylic acid or diol may preferably be a C18 to C26 dicarboxylic acid or diol, and more preferably a C18 or C26 dicarboxylic acid or diol. The C6 to C36 dicarboxylic acid or diol may preferably be a C18 dicarboxylic acid. The C6 to C36 dicarboxylic acid or diol may preferably be a C26 dicarboxylic acid.

The C6 to C36 diacid or diol may be derived from a C6 to C36 diacid or dialkyl ester which is obtained by a metathesis reaction, preferably a self-metathesis reaction. The metathesis reaction may occur in the presence of a catalyst. Suitable metathesis catalysts are disclosed in WO 2008/065187 and WO 2008/034552, and these documents in their entirety are incorporated herein by reference.

Additionally, or alternatively, component b) comprises at least one residue of a linear dicarboxylic acid having a carbon chain in the range from 4 to 12 carbon atoms, such as adipic acid, glutaric acid, succinic acid, pimelic acid, suberic acid, azelaic acid, sebacic acid, heptane dicarboxylic acid, octane dicarboxylic acid, nonane dicarboxylic acid, decane dicarboxylic acid, undecane dicarboxylic acid, and dodecane dicarboxylic acid. More preferably, b) comprises at least one residue of a linear dicarboxylic acid having 5 to 10 carbon atoms. Adipic acid is particularly preferred. This embodiment is particularly preferred where component b) comprises at least two or more residues of said C2 to C36 diacid or diols.

Preferably, b) may comprise at least one residue of a diol having from 2 to 10 carbon atoms, more preferably from 5 to 8 carbon atoms. This embodiment is particularly preferred where component b) comprises at least two or more residues of the C2 to C36 diacid or diols.

Suitable non-dimeric diols may be independently selected from straight chain aliphatic diols or branched aliphatic diols, or a combination thereof.

Suitable non-dimeric diols include straight chain aliphatic diols such as ethylene glycol, diethylene glycol, 1,3-propylene glycol, dipropylene glycol, 1,4-butylene glycol, 1,6-hexylene glycol (also known as hexanediol) and mixtures thereof, branched diols such as neopentyl glycol, 3-methyl pentane glycol, 1,2-propylene glycol, and mixtures thereof, and cyclic diols such as 1,4-bis(hydroxymethyl)cyclohexane and 1,4-cyclohexane-dimethanol and mixtures thereof. Hexanediol is particularly preferred.

Straight chain aliphatic diols may be independently selected from ethylene glycol, diethylene glycol, 1,3-propylene glycol (better known as 1,3-propanediol), 1,4-butanediol and 1,6-hexanediol. Such materials are particularly preferred

Branched aliphatic diols may be independently selected from 1,2-propylene glycol, 1,2-butanediol, 2,3-butanediol, and 1,3-butanediol.

The component b) may comprise at least one residue of a polyether diol, for example polyethylene glycol, polypropylene glycol or polytetrahydrofuran (also known as polytetramethylene ether glycol or PTMEG). The PTMEG may have a molecular weight (number average) of from 200 to 2000 g/mol, preferably from 200 to 1000, more preferably from 200 to 500 g/mol. This embodiment is particularly preferred where component b) comprises at least two or more residues of the C2 to C36 diacid or diols.

Component b) may comprise at least one residue of a polyol having a hydroxyl function greater than 2. Such polyols may include glycerol, pentaerythritol, or trimethylolpropane.

The component b) is preferably derived from a renewable and/or bio-based source. Suitably, component b) may have a renewable carbon content of at least 50 wt %, preferably at least 65 10 wt %, more preferably at least 80 wt % determined using ASTM D6866.

Suitably, the elastomeric polymer composition comprises an acrylate selected from one or more of a monoacrylate, a polyfunctional acrylate, an oligomeric acrylate, or derivatives thereof.

Preferably the acrylate is provided by an oligomeric acrylate or derivative thereof. Particular preferred oligomeric acrylates are urethane acrylates and epoxy acrylates. Such oligomeric acrylates may preferably be oligomeric acrylate resins, as further detailed below. Commercially available oligomeric acrylate resins include Photomer® from IGM Resins, Laromer® from BASF, Ebecryl® from Allnex, amongst others.

Preferable polyfunctional acrylates or derivatives thereof have a functionality equal to or greater than two. Suitably, the polyfunctional acrylate derivative may be selected from the group consisting of any monomeric or oligomeric molecule possessing acrylate, methacrylate, ethacrylate, and combinations thereof.

In one particularly preferred embodiment the polyfunctional acrylate derivative is a urethane acrylate oligomer.

In an alternative particularly preferred embodiment, the acrylate is a polyfunctional acrylate oligomer selected from an oligomeric epoxy acrylate resin or oligomeric polyether acrylate resin or oligomeric polyester acrylate or combinations thereof.

Preferably, the acrylate derivative may be selected from the group consisting of hexafunctional urethane acrylates, dipentaerythritol pentaacrylate, ethoxylated pentaerythritol tetraacrylate, di-trimethylolpropane tetraacrylate, pentaerythritol triacrylate, trimethylolpropane triacrylate, ethoxylated trimethylolpropane triacrylate, butanediol diacrylate, tripropylene glycol diacrylate, trimethylolpropane tri methacrylate, difunctional urethane acrylates, tetraacrylate monomer, polyester acrylate oligomers, and combinations thereof.

The elastomeric polymer composition may optionally contain one or more additive. Suitable and especially preferred additives are described below and include blowing agents, catalysts, pigments or dyes, fillers, surfactants, plasticisers, adhesion promoters, antioxidants, or UV-absorbing additives.

The polymer composition may comprise blowing agents, which may include water, fluorocarbons such as trichlorofluoromethane, dichlorodifluoromethane and trichlorodifluoroethane, or mixtures thereof. The inclusion of a blowing agent will depend upon the intended end use of the polymer matrix. Use of water as a blowing agent has environmental benefits and as such is preferred.

The polymer composition may comprise a catalyst. The catalyst may be present in a polymer resin to assist in post-processing or may be present in a polymer matrix due to being immobilised in the polymer matrix during processing. Such catalysts tend to be homogeneous catalysts. A preferred homogeneous catalyst is a salt of a basic anion group. Examples of useful cations include inorganic cations, preferably alkaline or alkaline earth metal cations, more preferably K+, Na+ and Li+, or organic cations like tetra-alkylammonium and tetra-alkylphosphonium salts, but also cations that do have a proton but are extremely non-acidic, for example protonated species of strongly basic organic bases as e.g. 1,8-diazabicyclo[5.4.0]undec-7-ene (DBU), 1,5-diazabicyclo[4.3.0]non-5-ene (DBN) or tetra-methylguanidine.

The polymer composition may comprise a pigment or dye. Suitable pigments include inorganic pigments such as transition metal salts; organic pigments such as azo compounds; and carbon powder.

The polymer composition may comprise a filler. Preferably the filler is a particulate filler. It is particularly preferred that the polymer composition comprises a filler.

The polymer composition may comprise filler in an amount of between 5 and 60 wt %, preferably between 10 and 50 wt %, most preferably between 20 and 40 wt %, based on the total weight of the polymer composition.

One preferred filler includes microspheres. A microsphere refers to a hollow body composed of organic or inorganic material having a diameter of 1 mm or less, preferably 500 μm or less. The advantage of these microspheres resides in that the cured product improves on elasticity compared to a product whereto no microspheres have been added. The density of the microspheres suitably ranges from 0.01 to 0.9 kg/dm³, preferably from 0.02 to 0.5 kg/dm³.

The amount of microspheres that is added to the polymer composition may be varied in accordance with the elasticity desired. Generally, the amount of microspheres will be selected from 0.01 to 100 parts by weight (pbw), preferably from 0.1 to 50 pbw, more preferably from 0.3 to 20 pbw per 100 pbw of the polymer composition. The amount of microspheres will be selected from 10 to 50 wt %, preferably from 20 to 40 wt %, more preferably from 25 to 30 wt % based on the total weight of the elastomeric polymer composition. As indicated above, the microspheres may have been made from inorganic or organic material. Suitable microspheres include silas balloons (hollow microspheres made of volcanic ash), pearlite, glass balloons, silica balloons, fly ash balloons, alumina balloons, zirconia balloons or carbon balloons. Additionally, suitable organic materials for the manufacture of hollow microspheres include phenolic resin, epoxy resin or urea, polystyrene, polymethacrylate, polyvinylalcohol, or styrene-acrylate polymer or vinylidene chloride polymer. Further, certain microspheres may have their surface coated with thermosetting resins.

Alternatively, or additionally, preferably the filler comprises cork particles, which have been proven to be suitable fillers for railway track applications.

Organic or inorganic fibres may also be used as fillers. The organic fibres may be synthetic, e.g., polyester or polyamide fibres, but also natural fibres may be used such as flax fibres. The filler material may also contain other polymers such as polystyrene, polyurethane, polyolefins, like polyethylene or polypropylene.

The fillers may also be recycled material. A very suitable recycled material is rubber granules, e.g., from granulated tyres.

Suitable inorganic fillers include glass fibres. The density of these fillers suitably ranges from 0.1 to 1.0 kg/dm³.

The elastomeric polymer composition may also contain fillers with a density greater than 1 kg/dm³, which fillers are suitably effective to reinforce the resulting cured polymer composition, such as fumed silica, precipitated silica, silica aerogel, carbon black, calcium carbonate, magnesium carbonate, diatomaceous earth, dolomite, clay, talc, titanium oxide, ferric oxide, zinc oxide, glass spheres and other filaments.

Another suitable filler that promotes the stiffness of the cured product is aggregate, i.e. coarse particulate material including sand, gravel, crushed stone, slag, and recycled concrete. The composition with aggregate provides a stable foundation in railway track structures whilst retaining the elasticity. Aggregates have a density above 1 kg/dm³. They are particularly useful in compositions that also contain microspheres. Due to the presence of the microspheres the density of the polymer composition might be below 1 kg/dm³. When such a combination is poured into a mould, e.g., the cavities and gaps in a railway track structure as described below, one runs the risk that water from the environment may be entrapped under the composition, thereby negatively affecting the load bearing capacity of a railway track structure or system. By adding aggregate to the polymer composition, not only the stiffness of the cured composition is promoted, but also the density of the resulting composition is enhanced, so that this density is above 1 kg/dm³. This ensures that the polymer composition will force water that may be present in the cavities and gaps of a railway track structure out of these cavities and gaps so that the load bearing capacity of the railway track structure is guaranteed. When the density of a pre-cure polymer composition is above 1 kg/dm³, the static pressure in the cavities and gaps of the railway track structure is larger, so that the polymer composition mixture (pre-cure polymer composition) flows better under any obstructions that may be present therein. Water is forced out, which ensures that no water is present, which could jeopardise electrical insulation and also ice formation at freezing conditions, which could damage the railway track structure.

Mixtures of fillers may also be used.

Preferably, the filler is selected from the group consisting of; cork particles, inorganic fillers, rubber granules, microspheres, and mixtures thereof.

More preferably, the filler comprises CaCO₃, and most preferably the filler comprises CaCO₃ particles.

The elastomeric polymer composition additive may comprise a surfactant. Preferred surfactants may include one or more of the following; silicone surfactants such as dimethylpolysiloxane, polyoxyalkylene polyol-modified dimethylpolysiloxane and alkylene glycol-modified dimethylpolysiloxane; and/or anionic surfactants such as fatty acid salts, sulphuric acid ester salts, phosphoric acid ester salts and sulphonates.

The polymer composition additive may comprise a stabiliser. Suitably, the stabiliser may be selected from a radical scavenger, antioxidant or ultra violet light absorbing agent. Suitable stabilisers can be selected by the skilled person dependent upon the intended end use of the polymer composition. Examples of the stabilisers include hindered phenol radical scavengers such as dibutylhydroxytoluene, pentaerythrityl-tetrakis[3-(3,5-di-t-butyl-4-hydroxyphenyl) propionate] and isooctyl-3-(3,5-di-t-butyl-4-hydroxyphenyl)propionate; antioxidants such as phosphorous acid compounds such as triphenylphosphite, triethylphosphite and triphenylphosphine; ultraviolet absorbing agents such as 2-(5-methyl-2-hydroxyphenyl)benzotriazole and a condensation product of methyl-3-[3-t-butyl-5-(2H-benzotriazole-2-yl)-4-hydroxyphenyl]propionate and polyethylene glycol.

Additionally, or alternatively, the elastomeric polymer composition may also contain one or more plasticizers to improve elongation properties of the cured composition or to enable to incorporation of a larger amount of filler. For instance, one or more of the following plasticizers may be used: phthalate esters such as dioctyl phthalate, dibutyl phthalate or butylbenzyl phthalate; aliphatic dibasic acid esters such as dioctyl adipate, isodecyl succinate or dibutyl sebacate; glycol esters such as diethylene glycol dibenzoate, or pentaerythritol ester; aliphatic esters such as butyl oleate or methyl acetyl ricinoleate; phosphate esters such as tricresyl phosphate, trioctyl phosphate or octyldiphenyl phosphate; alkylsulphonic acid esters, such as the phenol ester of alkyl sulphonic acid wherean the alkyl group contains from 8 to 25 carbon atoms, in particular alkane(C₁₀₋₂₁)sulphonic acid phenyl esters (sold as Mesamoll ex Lanxess), epoxy plasticizers such as epoxydized soybean oil or benzyl epoxy steareate; polyester plasticizers such as polyesters resulting from dibasic acids and divalent alcohols; polyether polyols such as polypropylene glycol and its derivatives; polystyrenes such as poly-a-methylstyrene or polystyrene; and other plasticizers such as polybutadiene, butadiene-acrylonitrile copolymer, polychloroprene, polyisoprene, polybutene or chlorinated paraffin. Plasticisers are usually used in an amount of from 0 to 150 pbw per 100 pbw of polymer composition.

In addition, additives including adhesion promoters (such as phenol resin, epoxy resin or organosilane adhesion promoters), antioxidants, or UV-absorbing agents may also be added to the elastomeric polymer composition as needed. As adhesion promoters, organosilane adhesion promoters are preferred for safety reasons.

It should be understood that the present elastomeric polymer composition provides an elastomer composition. That is to say that the elastomeric polymer composition can be considered to provide an elastomer polymer product having physical properties suitable to function as an elastomer. Such elastomer polymers products find particular utility in railway track structures and systems, particularly for providing vibration dampening when in use.

Suitably, the elastomer polymer compositions may be solid elastomers or microcellular elastomers. The elastomer composition may be a reinforced elastomer. Such reinforced elastomer compositions may further comprise reinforcing fibres or fibre mats; the reinforcing fibres may comprise glass fibres, carbon fibres or polyester fibres.

In one preferred embodiment, the elastomeric polymer compositions may be provided in the form of a foam sheet, which is particularly suitable for supporting concrete slabs with a fastened rail for use in railway track structures and systems. Such a foam sheet may be prefabricated from the elastomeric polymer composition according to the present invention. The foam sheet structure may be cellular, such as a flexible and/or microcellular foam. Preferably, the sheets are prefabricated separately to the alternative railway track components. The foam sheets can be placed in their destined location before placing the concrete slabs with fastened rail. The foam sheets offer support and vibration dampening of the railway track structure.

The size of the foam sheet may be chosen according to a pre-set standard, or their size may be particularly adjusted to match the length or width of the concrete slab. Preferably the foam sheet has a thickness of between 1 and 100 mm, more preferably between 5 and 60 mm, and most preferably between 15 and 30 mm.

Advantageously, the elastomeric polymer composition may have a tensile strength at break measured according to the ISO 37 norm of at least 0.1 MPa, preferably at least 0.5 MPa, more preferably at least 0.75 MPa, and most preferably at least 1 MPa.

Additionally, or alternatively, the elastomeric polymer composition may have a (maximum) elongation according to ISO 37 of at least 80%, preferably at least 90%, more preferably at least 100%, even more preferably at least 150%, especially preferably at least 550%, even more especially preferably at least 600%. Especially for the fastening, fixation or embedding of rail in railway track structures, a (maximum) elongation of at least 150% is preferred.

The present invention also provides a method of applying the elastomeric polymer composition described above in railway track structures, the method comprising the steps of:
i) preparing a polymer composition mixture by mixing
   A) the reaction product of an acetoacetylating agent and a polyol and wherein the polyol comprises:
      a) at least one dimer fatty residue selected from a dimer fatty acid residue, a dimer fatty diol residue and a dimer fatty diamine residue; and
      b) at least one residue of a linear or branched C2 to C36 diacid or diol; and
   B) the acrylate;
ii) applying the polymer composition mixture to at least one or more railway track structure component; and
iii) allowing the polymer composition mixture to cure.

As will be appreciated by the skilled person, in steps i) and ii) a pre-cure polymer resin is provided, whereas after the curing of step iii) a polymer matrix has been formed. Both the resin and the matrix can be understood to be elastomeric polymer compositions as described above. As such, generally, the method of the present invention includes the step of forming i) a pre-cure polymer resin, and subsequent ii) application of the resin followed by forming iii) a polymer matrix by curing the pre-cure polymer resin.

The method of step i) preparing the polymer composition mixture comprises mixing together A) the reaction product of an acetoacetylating agent and a polyol with B) the acrylate polymer constituents. This mixing step is to ensure that the two reactants are brought into intimate proximity resulting in a homogenous polymer composition.

Suitably, in step i) the molar ratio of the reaction product of an acetoacetylating agent and a polyol to the acrylate is in the range from between 1:0.2 to 1:4, preferably from between 1:0.25 to 1:3, more preferably from between 1:0.25 to 1:2.5, and most preferably from between 1:0.25 to 1:1.8.

The polymer composition curing in step iii) is achieved by cross-linking the polymer chains, and this may be achieved by any suitable means; however preferably the curing of step iii)) is achieved via a free radical polymerisation reaction or via a Michael addition reaction. More preferably, the curing step iii) is achieved via a Michael addition reaction.

Preferably, the curing of step iii) is performed at ambient temperature, and more preferably at room temperature. In particular, the curing of step iii) is achieved via a free radical polymerisation reaction or via a Michael addition reaction and performed at a temperature of between 0° C. and 35° C., preferably at a temperature between 15° C. and 30° C., and more preferably at a temperature between 20° C. and 25° C.

It is a significant advantage of the present invention that the curing step iii) can be achieved by carbon cross-linking by way of a Michael addition reaction. The ability to utilise the Michael addition reaction method for achieving carbon to carbon bonds is facilitated by the presence of the reactive acetoacetate groups of the acetoacetylating agent present in the reaction product of an acetoacetylating agent and a polyol as described above. The fact that the relatively mild reaction conditions for achieving the carbon to carbon bonds can be utilised in the present application method means that polymer application methods utilising isocyanate as a reactant can be replaced, but unexpectedly without the loss of product performance when the present elastomeric polymer composition is utilised in railway track structures as compared to polymers prepared utilising isocyanate. Such an isocyanate free method of polymer application has clear health and environmental benefits over a traditional isocyanate polymer based methods. Additionally, the fact that the Michael addition reaction may be achieved at ambient temperature and/or room temperature provides additional ease of application benefits. After curing, the resulting polymer is suitably elastic and has excellent adhesive strength.

Suitably, in method step ii) of applying the polymer composition mixture to at least one railway track structure component, the railway track structure component is a rail, and the polymer composition mixture is applied to at least one side (or face) of the rail. Preferably in step ii) the pre-cure polymer is applied to at least two, and more preferably three sides of the rail. As such, in a particularly preferred embodiment the method results in a railway track structure having a rail that is embedded on three sides by the cured elastomer composition or in a body of the cured elastomer composition. Such a method provides fastening, continuous support and insulation from vibrations and noise when the rail is in use in a railway track system.

Alternatively, in method step ii) the space underneath a rail can be filled with the composition according to the present invention so that the rail is supported and dampened in a vertical direction. In this case the elastomeric polymer will be applied in the space underneath the rail, onto the ground or other supporting surface.

Prior to performance of method step i) the A) reaction product of an acetoacetylating agent and a polyol and the B) acrylate may be separately packed. For example, A) the reaction product of an acetoacetylating agent and a polyol, and B) the acrylate may be packaged in at least two separate containers, such as e.g. rigid containers (cans, bottles, etc.), or flexible containers. The at least two separate containers may be different or of the same kind. As such, in step i) the mixing together of A) the reaction product of an acetoacetylating agent and a polyol and B) the acrylate may be performed by adding the contents of the at least two containers to a third container, or alternatively by combining the contents of the at least two containers in one of the containers. In this way, the amounts of A) the reaction product of an acetoacetylating agent and a polyol and B) the acrylate may be pre-determined and separately packed, and mixing can easily be done in-situ close to the location of the rail track structure to which the polymer composition is to be applied without the need for special weighing or dosing equipment on site.

Alternatively, weighing/dosing and mixing may be performed automatically, for example, by a dosing and mixing machine at the desired railway track structure location.

In step ii) preferably the polymer composition mixture is applied in a layer with a thickness of at least 5 mm, more preferably, the polymer composition mixture is applied in a layer with a thickness of from 5 to 300 mm, and most preferably the layer of polymer composition mixture is applied in a thickness of from 10 to 200 mm.

It is advantageous to apply the polymer composition in a cavity or channel which is formed by one of the substrates of a railway track structure to which the cured product is meant to adhere. Therefore, the substrate into which the polymer composition is applied is preferably a steel or concrete channel encompassing a second substrate, namely a rail for a railroad, underground or tramway. As such, in one particularly preferred embodiment, after the mixing step of step i) the polyol and the acrylate, the resulting polymer composition mixture (also pre-cure polymer composition) is preferably applied in a gap, cavity, channel or mould. Therefore, the layer mentioned above may form in said gap, cavity, channel, or mould. In the case of a mould, this may be removed once the elastomer polymer composition has cured, such that the mould does not form part of the railway track structure for use in a railway track system.

Where deemed advantageous the method may also include a pre-treatment step. This may preferably be performed prior to step ii). Preferably, the method may include one or more of the following pre-treatment steps: application of a primer, grinding and cleaning.

Suitably the component to which the elastomeric polymer composition is to be applied is first pre-treated to ensure that the component is free from laitance, curing compounds, release agents and contaminations such as dirt, oil, and grease. Suitable methods to carry out such pre-treatments include wet or dry blast cleaning and grinding.

Where desirable a primer can be selected from a range of commercial products. Suitable primers include commercial silane resin-based primers, epoxy primers and UV curing acrylate-based primers. In some cases, it may be preferable not to use a primer in the adhesion of the cured elastomer product or matrix to a surface. However, in all cases the adhesion of the applied elastomeric polymer composition is improved if all loose parts, dust and dirt, rust and other contaminants have been removed before the composition is applied to the desired component. However, it is advantageous to apply a primer onto the component first.

The invention furthermore provides a railway track structure comprising the elastomeric polymer composition according to the invention as described above.

The invention also provides a railway track structure which is obtainable via method for applying a polymer composition in railway track structures according to the invention as described above. In particular, it provides a rail embedded in a body of a synthetic resin, wherein the synthetic resin is the cured composition or polymer matrix as described above.

Alternatively, there is a provided a railway track structure comprising a foam sheet formed from the elastomeric polymer composition. The foam sheet may be prefabricated from the elastomeric polymer composition according to the present invention, as described above. In this case, the foam sheet structure may be cellular, such as a flexible and/or microcellular foam. The foam sheet can be placed in its desired location before placing concrete slabs with fastened rail to provide a railway track structure.

Alternatively, there is a provided a railway track structure comprising the fastening of a concrete block on which rails have been fastened to a substrate, e.g., a concrete tray, bridge, or tunnel, such that the concrete block is elastically fixed to the substrate by the elastomer polymer composition, thereby providing isolation to noise and vibrations. Similar to the construction that has been disclosed in WO 2008/040549, the fastening of a polymeric tray in another polymeric tray is also possible so that a support is created for a concrete block, and elastomeric polymer compositions according to the present invention may be utilised in such polymeric trays.

A further alternative embodiment is a railway track structure comprising the elastomeric polymer composition in a base plate. The base plate may also comprise steel or alternative polymeric plates, e.g., polyamide, that are cast in the elastomeric polymer composition according to the invention. Rails may subsequently be fastened to these base plates. The base plates may subsequently be fastened to a substrate, e.g., a road, tunnel, or bridge.

As indicated above, the present invention also provides the use of an elastomeric polymer composition, as described above, in railway track structures and systems.

In particular the elastomeric polymer composition is used for the fastening of rail components in railway track structures, which can then be used in forming railway track systems. Preferably, the elastomeric polymer composition is used in the embedding of rail components in a cured polymer composition (or polymer matrix). More preferably, the elastomeric polymer composition is used to provide a rail that is embedded on three sides by the cured polymer composition (or polymer matrix). This provides fastening, continuous support and insulation from vibrations and noise when the embedded rail is used in forming a railway track structure.

All of the features described herein may be combined with any of the above aspects, in any combination.

### FIGURES

The invention will be further explained by means of the accompanying Figures in which:

FIG. 1 shows a simplified cross-section of an embodiment of the invention wherein a channel is filled with the composition according to the invention.

FIG. 2 shows a simplified cross-section of an alternative embodiment of the invention with an embedded rail.

FIG. 3 shows a simplified cross-section of a further embodiment where a mould (not shown) has been utilised to form the structure.

FIG. 4 shows a simplified cross-section of another embodiment wherein the composition according to the invention is used to fill a channel.

FIG. 5 shows a simplified cross-section of an alternative embodiment of an embedded rail.

FIG. 6 shows a simplified cross-section of a direct fastening structure.

FIG. 7 shows a simplified cross-section of an embedded block structure.

FIG. 8 shows a simplified cross-section of a rail component coated with a composition according to the invention.

FIG. 9 shows foam sheets fully supporting the bottom and both sides of a concrete slab in a railway track system.

FIG. 10 shows multiple smaller foam sheets supporting a concrete slab in a railway track system.

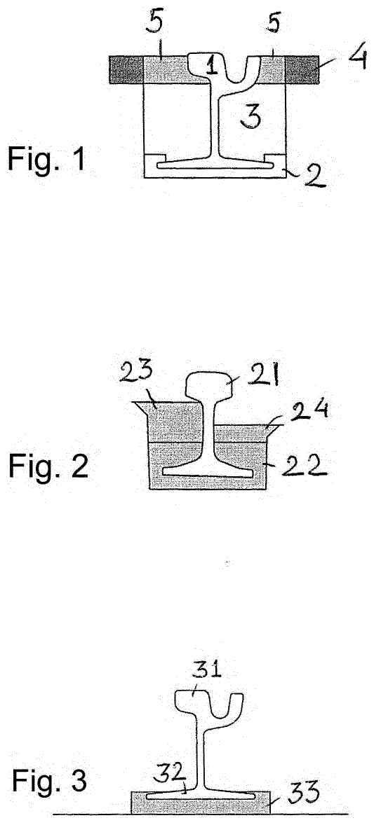

FIG. 1 shows a steel rail 1 that has been lowered in to a channel. The channel is located in a road. The road is covered with an upper layer of asphalt 4. The rail 1 is conventionally fixed using a first body of elastic polymer material 2 and a second body of elastic polymer material 3, thereby providing a strong fastening of the rail and satisfactory dampening of the noise and vibration when a train or tram runs over the rail. The bodies 2 and 3 are only partly filling the channel to allow a gap under the surface of the road. This gap is subsequently filled by the elastomeric composition according to the present invention, and the composition is allowed to cure to provide elastic polymer bodies 5. In this way the composition combines adhesion to the asphalt layer 4 of the road and to the steel rail 1 with its properties of elasticity and strength. In an alternative embodiment the polymer material in the bodies 2 and 3 may be formed from a different polymer and one or both may consist of a polyurethane composition.

In FIG. 2 a rail 21 is placed into a channel that has been provided for the rail 21. The rail 21 is fixed in its desired position by the elastomer polymer. The composition according to the present invention is mixed and applied into the channel such that the rail 21 is partly covered. The elastomeric composition is allowed to cure and an elastic polymer body 22 is thus created. After curing of the body 22 the channel is further filled with the present polymer composition to provide elastic polymer bodies 23 and 24. This embodiment is especially convenient when it is desired to have the rail 21 embedded in elastic polymer material at two different height levels, as shown by the different levels of bodies 23 and 24. If such height difference is not desired, it is also possible to fill the channel in one step so that only one body, is obtained filling the entire channel to the desired height.

To obtain the embodiment shown in FIG. 3, a mould is first created (not shown) above which a rail 31 is located such that the rail 31, provided with a rail foot 32, does not touch the bottom of the mould. The remaining space is filled with a composition according to the invention and the composition is allowed to cure to provide an elastic body 33. The mould is removed and the rail with an elastic body 33 can be used in preparing railway tracks systems. In this way, the embedded rail structure can be pre-fabricated off site, and brough on-site to lay the desired railway track system.

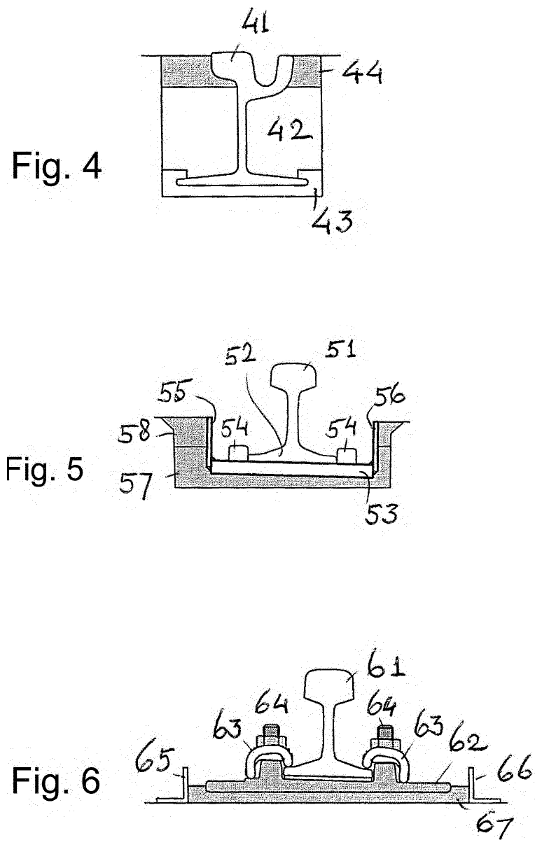

FIG. 4 is similar to FIG. 1, but there is no asphalt layer 4 present. Here a channel has been provided in a concrete road (not shown), into which a steel rail 41 is fixed via elastic polymer bodies 43 and 44. Since body 42 only partly fills the channel, the remaining channel is filled with a composition according to the invention, yielding an elastic body 44. The body 44 has excellent adhesion properties to the steel rail. Further, it also bonds with the concrete of the road.

FIG. 5 shows a different version of an embedded rail structure. In this embodiment a rail 51 contains a rail foot 52. The rail foot 52 is fastened to a tray 53 via connecting means 54. The tray 53 may be made from a variety of materials, such as iron or steel. The tray 53 comprises side walls 55 and 56.The rail 51, rai foot 52 and tray 53 structure, is lowered into a channel that is destined for the rail, a gap is formed between the side walls of the tray 55 and 56 and the walls of the channel. This gap is filled in two steps; in a first step a layer of the present composition is applied, which after curing provides elastic body 57, and this is followed by a second step to provide for a second body 58; this second body 58 may be of any suitable polymer material, including the present elastomer polymer although an alternative polymer could be utilised.

FIG. 6 shows a direct fastening structure wherein a rail 61 is fastened to a base via a fastening means of a plate 62 via extensions 63 and hooks 64. It is evident that alternative or additional fastening means may also be applied. Two side walls 65 and 66 are provided to form a mould between them. The rail 61 with base plate 62 is lowered into this mould without touching the bottom, to create a gap. The gap is filled with the elastomeric polymer composition according to the invention to provide an elastic layer 67.

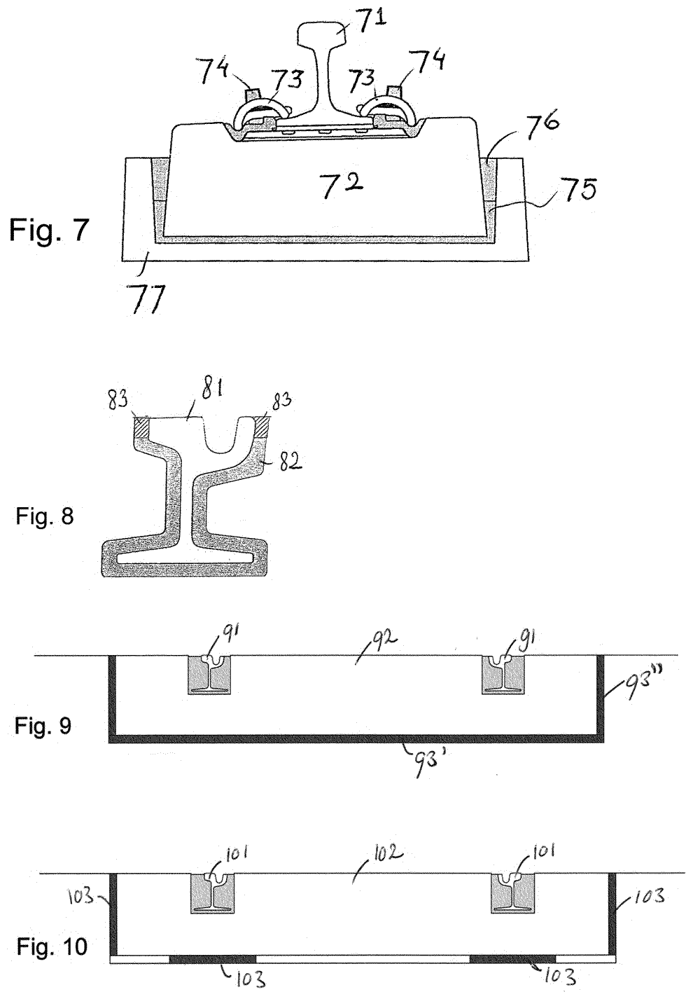

FIG. 7 shows the use of the present invention in an embodiment, similar to the rail systems described in WO 2008/040549. It shows a rail 71 that is fastened to a block 72, made from concrete. Polymer concrete and other materials may also be used for the manufacture of the block. The rail 71 is fastened by conventional fastening means using fastening extensions 74 that are fixed to the block and hooks 73 that fasten the lower part of the rail 71. The block 72 is lowered into a tray 77 to form a gap 76. The gap 76 that is formed is then filled in two steps with the elastomeric polymer composition according to the invention. Such rail and block railway track structures may be prefabricated off site and placed in a destined location to create a railway track system. The structure positioning may be done at the desired location in the same way as described in WO 2008/040549.

FIG. 8 shows a cross-section of a rail 81 that is for a major part covered with a layer 82 made from the elastomer polymer composition according to the present invention. The rail 81 with the polymer layer 82 is prefabricated. When this rail is placed at its destined position, it is positioned in a channel without touching the walls of the channel. Concrete is cast underneath and alongside the rail 81, thus forming a railway track structure. The layer 82 that may be relatively thick, and thus provides noise and vibration damping. Alternatively, the layer 82 may be relatively thinner and thus provides electrical insulation and corrosion resistance. The rail 81 is mechanically fixated to a surface. At the top of the rail two elastic bodies 83 may be applied, which have skid resistance properties; these elastic bodies 83 are formed from alternative polymer materials and may be polyurethane or epoxy type materials.

FIG. 9 shows two rails 91 fastened by conventional means to a slab of concrete 92. Foam sheets 93′ and 93″ have been prefabricated from the elastomeric composition according to the present invention. The foam sheets have been prefabricated separately away from the railway track structure and were placed in their destined location before placing slab 92 and rails 91. The foam sheets offer support and vibration dampening of the railway track system. In FIG. 9, the size of the foam sheets is such that the bottom and sides of the concrete slab 92 are fully enclosed.

FIG. 10 shows two rails 101 fastened by conventional means to a slab of concrete 102. The foam sheets 103 have been prefabricated from the elastomeric polymer composition according to the present invention. The foam sheets have been prefabricated separately, away from the railway track structure and were placed in their destined location before placing slab 102 and rails 101. The foam sheets offer support and vibration dampening of the railway track system. In FIG. 10, the size of the foam sheets is such that the bottom and sides of the concrete slab 102 are not fully enclosed.

### EXAMPLES

The present invention will now be described further by way of example only with reference to the following Examples. All parts and percentages are given by weight unless otherwise stated.

It will be understood that all tests and physical properties listed have been determined at atmospheric pressure and room temperature (i.e. about 20° C.), unless otherwise stated herein, or unless otherwise stated in the referenced test methods and procedures.

Materials as used in the following examples are identified as follows:
1,4-butanediol—a bio-based version as available ex BioAmber
1,6-hexanediol—ex BASF
Adipic acid (C 6 dicarboxylic acid)—a bio-based version ex Verdezyne
Pripol™ 1006 dimer fatty diacid—a hydrogenated C₃₆ dicarboxylic acid ex Croda
Pripol™ 1013 dimer fatty diacid—an unhydrogenated C₃₆ dicarboxylic acid ex Croda
Neopentyl glycol—ex Perstorp
Trimethylolpropane—ex Perstorp
Caprolactone—CAPA-monomer ex Perstorp
Tert-butyl acetoacetate—tBAA ex Eastman
Photomer™ 6210—a urethane acrylate ex IGM Resins
Photomer™ 6891—a urethane acrylate ex IGM Resins
Photomer™ 3316—an epoxy acrylate ex IGM Resins
SuprasecTM 2030—a methylene diphenyl diisocyanate (MDI) prepolymer ex Huntsman
PTMEG—Terathane™—number average molecular weight 2000 ex Invista
Desmophen™ 2061BD—a commercial polyol of polypropylene glycol—number average molecular weight 2000 ex Covestro
ImerSeal™ 36S—a commercial calcium carbonate polymer filler ex Imersys
Corkelast™ VA-60—Filled PU system based on polypropylene glycol ex. edilion)(sedra
Desmodur™ E15—a commercial toluene diisocyanate (TDI) prepolymer ex Covestro

Test methods:
Number average molecular weight was determined by end group analysis with reference to the hydroxyl value.
Weight average molecular weight was determined by end group analysis with reference to the hydroxyl value.
The hydroxyl value is defined as the number of mg of potassium hydroxide equivalent to the hydroxyl content of 1 g of sample and was measured by acetylation followed by hydrolysation of excess acetic anhydride. The acetic acid formed was subsequently titrated with an ethanolic potassium hydroxide solution.
The acid value is defined as the number of mg of potassium hydroxide required to neutralise the free fatty acids in 1 g of sample and was measured by direct titration with a standard potassium hydroxide solution.
Elongation was measured using an Instron tensile tester according to ISO 37 using dumb-bell test pieces of type 2 unless otherwise specified.
Tensile Strength was measured using an Instron tensile tester according to ISO 37 using dumb-bell test pieces of type 2 unless otherwise specified.
Modulus was calculated as the tensile strength required to achieve a predetermined elongation.
Water absorption after 7 days immersion was measured according to ISO 62
The compression set was measured according to ISO 1856, method B (ISO 1856B)
Volume resistivity was measured according to EN 62631, part 3-1 (EN 62631-3-1).

### Example 1

### Preparation and Examples of the Reaction Product of an Acetoacetylating Agent and a Polyol

### P1—Dimer Fatty Acid and Diol Containing Polyol

In a reactor equipped with a stirrer, a thermometer, a gas inlet, and condenser, 100 parts by weight of Pripol 1006 and 21 parts butanediol, were charged. Subsequently, the temperature of the reactor was raised from ambient temperature to 220-230° C. under normal pressure under a nitrogen atmosphere. Under these conditions an esterification reaction was conducted to obtain a polyester polyol. The esterification reaction was conducted until the desired acid/hydroxyl value was observed; in this example the polyester polyol obtained had an acid value of less than 1 mg KOH/g and a hydroxyl value of 56 mg KOH/g. The polyester polyol obtained had a calculated number average molecular weight of about 2000 g/mol and an 85% renewable content.

### P2—Dimer Fatty Acid, Aliphatic Diacid and Diol Containing Polyol

Three different reactions were carried out utilising Pripol 1006, adipic acid and hexanediol as the reactants; the variations in the reaction resulted in polyols of differing number average molecular weight, as detailed below.

### P2A

In a reactor equipped with a stirrer, a thermometer, a gas inlet, and condenser, 50 parts by weight of Pripol 1006, 50 parts adipic acid, 68.9 parts hexanediol, were charged. Subsequently, the temperature of the reactor was raised from ambient temperature to 220-230° C., under normal pressure in a nitrogen atmosphere. Under these conditions an esterification reaction was conducted until the desired acid/hydroxyl value was observed. In this example the polyester polyol obtained had an acid value of less than 1 mg KOH/g and a hydroxyl value of 110 mg KOH/g. The polyester polyol obtained had a calculated number average molecular weight of about 1000 g/mol and a 30% renewable content.

### P2B

In a reactor equipped with a stirrer, a thermometer, a gas inlet, and condenser, 50 parts by weight of Pripol 1006, 50 parts adipic acid, 59 parts hexanediol, were charged. Subsequently, the temperature of the reactor was raised from ambient temperature to 220-230° C., under normal pressure in a nitrogen atmosphere. Under these conditions an esterification reaction was conducted until the desired acid/hydroxyl value was observed. In this example the polyester polyol obtained had an acid value of less than 1 mg KOH/g and a hydroxyl value of 56 mg KOH/g. The polyester polyol obtained had a calculated number average molecular weight of about 2000 g/mol and a 30% renewable content.

### P2C

In a reactor equipped with a stirrer, a thermometer, a gas inlet, and condenser, 50 parts by weight of Pripol 1006, 50 parts adipic acid, 56.3 parts hexanediol, were charged. Subsequently, the temperature of the reactor was raised from ambient temperature to 220—230° C., under normal pressure in a nitrogen atmosphere. Under these conditions an esterification reaction was conducted until the desired acid/hydroxyl value was observed. In this example the polyester polyol obtained had an acid value of less than 1 mg KOH/g and a hydroxyl value of 37 mg KOH/g. The polyester polyol obtained had a calculated number average molecular weight of about 3000 g/mol and a 30% renewable content.

### P3—Dimer Fatty Acid and Glycol Containing Polyol

In a reactor equipped with a stirrer, a thermometer, a gas inlet, and condenser, 100 parts by weight of Pripol 1013 and 25 parts neopentyl glycol, were charged. Subsequently, the temperature of the reactor was raised from ambient temperature to 220-230° C., under normal pressure in a nitrogen atmosphere. Under these conditions an esterification reaction was conducted until the desired acid/hydroxyl value was observed. In this example the polyester polyol obtained had an acid value of less than 1 mg KOH/g and a hydroxyl value of 56 mg KOH/g. The polyester polyol obtained had a calculated number average molecular weight of about 2000 g/mol and an 84% renewable content.

### P4—Dimer Fatty Acid, Triol and Polyol Containing Polyol

In a reactor equipped with a stirrer, a thermometer, a gas inlet, and condenser, 100 parts by weight of Pripol 1006 and 47 parts trimethylolpropane, were charged. Subsequently, the temperature of the reactor was raised from ambient temperature to 220-230° C., under normal pressure in a nitrogen atmosphere. Under these conditions an esterification reaction was conducted until the desired acid/hydroxyl value was observed. In this example the polyester polyol obtained had an acid value of less than 1 mg KOH/g and a hydroxyl value of 282 mg KOH/g. The polyester polyol obtained was retained in the reactor and was further modified by introduction of a CAPA polyol, as per the method steps below.

The temperature of the reactor was lowered to 160° C. after which 60 parts of caprolactone (CAPA-monomer ex Perstorp) and 0.05 parts of tin (II) octoate as polymerisation catalyst, were charged. Under these conditions a ring opening polymerisation reaction was conducted until the desired acid/hydroxyl value were observed. The final polyester polyol obtained had an acid value of less than 1 mg KOH/g and a hydroxyl value of 210 mg KOH/g. The polyester polyol obtained had a calculated number average molecular weight of about 1000 and a 55% renewable content.

### P5—Dimer Fatty Acid and Diol Containing Polyol

In a reactor equipped with a stirrer, a thermometer, a gas inlet, and condenser, 100 parts by weight of Pripol 1006 and 28 parts hexanediol, were charged. Subsequently, the temperature of the reactor was raised from ambient temperature to 220-230° C., under normal pressure in a nitrogen atmosphere. Under these conditions an esterification reaction was conducted until the desired acid/hydroxyl value was observed. In this example the polyester polyol obtained had an acid value of less than 1 mg KOH/g and a hydroxyl value of 56 mg KOH/g. The polyester polyol obtained had a calculated number average molecular weight of about 2000 g/mol and an 81% renewable content.

### P6a—Dimer Fatty Acid, Diacid, Diol and Polyol Containing Polyol

In a reactor equipped with a stirrer, a thermometer, a gas inlet, and condenser, 50 parts by weight of Pripol 1006, 50 parts adipic acid and 68.5 parts hexanediol, were charged. Subsequently, the temperature of the reactor was raised from ambient temperature to 220-230° C., under normal pressure in a nitrogen atmosphere. Under these conditions an esterification reaction was conducted until the desired acid/hydroxyl value was observed. In this example the polyester polyol obtained had an acid value of less than 1 mg KOH/g and a hydroxyl value of 110 mg KOH/g. The polyester polyol obtained was retained in the reactor and was further modified by introduction of a CAPA polyol, as per the method steps below.

The temperature of the reactor was lowered to 160° C. after which 188 parts of caprolactone (CAPA-monomer ex Perstorp) and 0.05 parts of tin (II) octoate as polymerisation catalyst, were charged. Under these conditions a ring opening polymerisation reaction was conducted until the desired acid/hydroxyl value were observed. The final polyester polyol obtained had an acid value of less than 1 mg KOH/g and a hydroxyl value of 56 mg KOH/g. The polyester polyol obtained had a calculated number average molecular weight of about 2000 and a 18% renewable content.

### P6b—Dimer Fatty Acid, Diacid, Diol and Polyol Containing Polyol

In a reactor equipped with a stirrer, a thermometer, a gas inlet, and condenser, 50 parts by weight of Pripol 1006, 50 parts adipic acid and 68.5 parts hexanediol, were charged. Subsequently, the temperature of the reactor was raised from ambient temperature to 220-230° C., under normal pressure in a nitrogen atmosphere. Under these conditions an esterification reaction was conducted until the desired acid/hydroxyl value was observed. In this example the polyester polyol obtained had an acid value of less than 1 mg KOH/g and a hydroxyl value of 110 mg KOH/g. The polyester polyol obtained was retained in the reactor and was further modified by introduction of a CAPA polyol, as per the method steps below.

The temperature of the reactor was lowered to 160° C. after which 370 parts of caprolactone (CAPA-monomer ex Perstorp) and 0.05 parts of tin (II) octoate as polymerisation catalyst, were charged. Under these conditions a ring opening polymerisation reaction was conducted until the desired acid/hydroxyl value were observed. The final polyester polyol obtained had an acid value of less than 1 mg KOH/g and a hydroxyl value of 56 mg KOH/g. The polyester polyol obtained had a calculated number average molecular weight of about 2000 and a 12% renewable content.

### Comparative Examples:

### C7—(Non-Dimer Containing) Polyether Based Polyol

PTMEG- Terathane™ polyether based polyol with a hydroxy value of 56 mg KOH/g.

### C8—(Non-Dimer Containing) Diacid and Diol Containing Polyol

In a reactor equipped with a stirrer, a thermometer, a gas inlet and condenser, 100 parts by weight of adipic acid, 91 parts hexanediol, were charged. Subsequently, the temperature of the reactor was raised from ambient temperature to 220-230° C., under normal pressure in a nitrogen atmosphere. Under these conditions an esterification reaction was conducted until the desired acid/hydroxyl value was observed. In this example the polyester polyol obtained had an acid value of less than 1 mg KOH/g and a hydroxyl value of 56 mg KOH/g. The polyester polyol obtained had a calculated number average molecular weight of about 2000 g/mol and 0% renewable content.

General Method for Preparation of Reaction Product of Polyol with an Acetoacetylating Agent

Each of the polyester polyols prepared above were subsequently modified by reaction with an acetoacetylating agent containing acetoacetate.

In a reactor equipped with a stirrer, a thermometer, a gas inlet, and a condenser, 100 parts by weight of each of a polyol as prepared above and 15.8 parts by weight of tert-butyl acetoacetate (Eastman™ t-BAA) were charged.

The temperature of the reactor was raised to 150-160° C. under normal pressure in a nitrogen atmosphere. Under these conditions the reaction is continued until the theoretical amount of tertiary-butanol distillate was achieved.

If necessary, a vacuum can be applied to ensure the completion of the reaction. Gel chromatography can be used to identify the reaction completion.

### Example 2

### Preparation and Analysis of Elastomer Polymers

Various elastomer polymers were prepared as detailed in Table 1, below. The polymers are identified by reference to the example polyol they contain as identified above, i.e. example polymer P1 contains the reaction product of polyol P1, etc. A C-Michael addition reaction performed at room temperature was employed when utilising example materials as described above in combination with one of two commercially available acrylate-based oligomers. The elastomer polymers were prepared using a 2-component process. The C-Michael crosslinking achieved within the polymer matrix can be accelerated by the use of an organic base catalyst like DBU (1,8-diazabicyclo[5.4.0]undec-7-ene) if desirable.

The example materials and acrylate based oligomer were reacted in a molar ratio of 1:1.2 to 1.8, as noted below in Table 1. The two commercially available acrylate based oligomers tested were Photomer™ 6210 (urethane acrylate ex IGM Resins) and Photomer 6891 (urethane acrylate ex IGM Resins). The resulting elastomer polymer is therefore considered to be a polyurethane based product but is advantageously prepared in the absence of isocyanate.

Comparative materials were produced utilising comparative polyol 7 and comparative polyol 8 (non-dimer containing material which required curing at an elevated temperature) as described above, and also a further material consisting of commercially available Desmophen 2061BD reacted with Suprasec™ which was made to represent a commercially utilised polyether polyol in combination with a polymeric isocyanate comparative example; this is termed C9 in the table below. Hence, C9 provides an elastomeric polymer prepared by the addition of isocyanate, which is undesirable.

TABLE 1
Crosslinked unfilled 2-component system

| Example | Photomer | E modulus | Fₘₐₓ | DL @ Fₘₐₓ |
|---|---|---|---|---|
| (mol ratio) | (mol ratio) | (MPa) | (MPa) | (%) |
| P1 (1.0) | 6210 (1.4) | 1.2 | 0.9 | 128 |
| P1 (1.0) | 6891 (1.2) | 1.5 | 0.9 | 127 |
| P1 (1.0) | 6891 (1.3) | 1.5 | 1.0 | 120 |
| P1 (1.0) | 6891 (1.4) | 1.5 | 0.9 | 110 |
| P1 (1.0) | 6210/3316:90/ | 1.4 | 0.9 | 132 |
| | 10 (1.4) | | | |
| P2c(1.0) | 6210 (1.4) | 9 | 2 | 82 |
| P3 (1.0) | 6891 (1.5) | 1.4 | 0. | 128 |
| P3 (1.0) | 6891 (1.7) | 0.5 | 0.5 | 148 |
| P3 (1.0) | 6210 (1.4) | 0.7 | 0.6 | 115 |
| P3 (1.0) | 6210 (1.5) | 0.9 | 0.7 | 125 |
| P3 (1.0) | 6210 (1.8) | 1.1 | 0.8 | 125 |
| P4 (1.0) | 6210 (1.4) | 4.7 | 2.1 | 58 |
| P6a(1.0) | 6210 (1.4) | 4.4 | 1.4 | 47 |
| P6b(1.0) | 6210 (1.4) | 30 | 2.7 | 66 |
| C7(1.0) | 6210(1.4) | 1.6 | 1.3 | 95 |
| C8(1.0)* | 6210(1.4) | 1.4 | 0.9 | 99 |
| C9 Desmophen | Suprasec | 0.7 | 0.9 | 260 |
| 2061BD (1.0) | 2030 (1.0) | | | |

*elastomer had to be prepared at an elevated temperature of between 60° C. to 90° C. to achieve curing.

When considering the mechanical data detailed in Table 1, the C-Michael polymer matrix materials which are formed at room temperature from the reaction product of an acetoacetylating agent and a polyol comprising a dimer fatty residue and a diol or diacid residue in combination with an acrylate oligomer provide E-modulus and tensile strength properties which are higher than the comparative commercial polyurethane (PU) elastomer material C9. As will be appreciated by the skilled person, although the materials in accordance with the present invention tested here provide an elongation which does not reach the high level of the commercial PU, this is the result of the higher modulus obtained. On balance, when considering the higher modulus and tensile strength obtained a commercially acceptable elongation is reached for the materials of the present invention, with the advantageous omission of isocyanate from the preparation of the polymer matrix material. Furthermore, it is known that ether bonds have a reduced thermo-oxidative stability as compared to ester bonds and therefore the presence of the polyester polyol-based backbone in the materials provided by the present invention is preferable. In addition, as noted above, the elastomer polymer based on C8 (containing no dimer) needed to be cured at elevated temperature whereas the elastomer polymer compositions in accordance with the present invention were advantageously capable of being cured at room temperature.

In a further experiment, various elastomer polymers were prepared as detailed in Table 2, below, via a C-Michael addition reaction at room temperature utilising the example reaction products of an acetoacetylating agent and a polyol as described above, in combination with one of two commercially available acrylate-based oligomers. In this case, the elastomer polymers were prepared using a 2-component process and included a filler, ImerSeal 36S. The C-Michael crosslinking achieved within the polymer matrix can be accelerated by the use of an organic base catalyst like DBU (1,8-diazabicyclo[5.4.0]undec-7-ene) if desirable.

The reaction product of an acetoacetylating agent and a polyol and the acrylate based oligomer were reacted in a molar ratio of 1:1.2 to 1.8, as noted below in Table 2. The two commercially available acrylate based oligomers tested were Photomer™ 6210 (urethane acrylate ex IGM Resins) and Photomer™ 6891 (urethane acrylate ex IGM Resins). The resulting elastomer polymer is therefore a polyurethane based product but is advantageously prepared in the absence of isocyanate.

A comparative material, denoted C10 in Table 2, was produced consisting of commercially available PPG ex Sigma Aldrich and Suprasec™ 2030. C10 was made to provide a polymeric isocyanate containing comparative example. Hence, C10 is a filled elastomer polymer prepared by the addition of isocyanate, which is undesirable.

TABLE 2
Crosslinked filled 2 component system (+29 wt % filler)

| Example | Photomer | E modulus | Fₘₐₓ | DL @ Fₘₐₓ |
|---|---|---|---|---|
| (mol ratio) | (mol ratio) | (MPa) | (MPa) | (%) |
| P1 (1.0) | 6210 (1.4) | 2.6 | 1.2 | 173 |
| P1 (1.0) | 6891 (1.2) | 2.9 | 1.1 | 137 |
| P1 (1.0) | 6891 (1.3) | 3.2 | 1.1 | 120 |
| P1 (1.0) | 6891 (1.4) | 3.2 | 1.1 | 112 |
| P3 (1.0) | 6891 (1.4) | 2.6 | 1 | 121 |
| P3 (1.0) | 6891 (1.5) | 2.4 | 1 | 158 |
| P3 (1.0) | 6891 (1.7) | 2.3 | 1.2 | 183 |
| P3 (1.0) | 6210 (1.8) | 2.8 | 1.2 | 174 |
| Desmophen | Desmodur | 2.5 | 1.3 | 160 |
| 2061DB (1.0) | E15 (1.0) | | | |

When considering the mechanical data detailed in Table 2 above when a filler is included the C-Michael polymer matrix materials which are formed from the reaction product of an acetoacetylating agent and a polyol in combination with an acrylate oligomer provide E-modulus and tensile strength properties which are in a comparable range to the comparative commercial polyurethane (PU) elastomer materials. Additionally, it can be noted that the inclusion of the filler improves the elongation properties of the materials of the present invention such that they are comparable with the comparative commercial example, but with the advantageous omission of isocyanate from the polymer matrix material.

C10 is an example which is comparable to a composition such as currently used in railway track systems. For railway track systems, the E-modulus is preferably between 2.3 and 3.1 MPa. This E-modulus range offers stability of the rail/track against horizontal forces, yet the material is not too stiff, because a certain level of elasticity is required for vibration dampening.

Table 3, below, provides further information regarding varying filler amounts in a specific system.

TABLE 3
Crosslinked filled 2 component system (varying filler amounts)

| Example | Photomer | Filled with | E modulus | Fₘₐₓ | DL @ |
|---|---|---|---|---|---|
| (mol ratio) | (mol ratio) | CaCO₃ (wt %) | (MPa) | (MPa) | Fₘₐₓ (%) |
| P1 (1.0) | 6210 (1.4) | 0 | 1.19 | 0.85 | 128 |
| P1 (1.0) | 6210 (1.4) | 20 | 1.86 | 1.02 | 155 |
| P1 (1.0) | 6210 (1.4) | 26 | 2.33 | 1.12 | 161 |
| P1 (1.0) | 6210 (1.4) | 29 | 2.64 | 1.15 | 173 |
| P1 (1.0) | 6210 (1.4) | 34 | 3.09 | 1.15 | 169 |
| P1 (1.0) | 6210 (1.4) | 40 | 4.01 | 1.15 | 161 |

As can be seen from Table 3, compositions comprising more than 20% and less than 40%, such as between 26 and 34% filler have a suitable E-modulus for use in railway track systems. Compositions with at least 20% filler, preferably at least 26% filler have a suitable tensile strength. Suitable elongation properties are also obtained in the case of at least 20% filler.

Table 4 below provides information regarding further properties of a filled system compared to a polyurethane material that is commercially used as an embedding material in railway track systems.

TABLE 4
Crosslinked filled 2 component system (further properties)

| | Water | Volume resistivity | | Compression |
|---|---|---|---|---|
| | absorption | (EN 62631-3-1) (Ωm) | | set |
| | after 7 days | | After storage | (ISO 1856 |
| | immersion | | in 0.1n NaCl | Method-B) |
| Material | (ISO 62) (%) | Dry | solution | (%) |
| Corkelast VA-60 | 4.50 | 224 · 10⁶ | 35 · 10⁶ | 12 |
| Filled | 0.60 | 583 · 10⁶ | 354 · 10⁶ | 3 |
| composition | | | | |
| according to the | | | | |
| invention (entry | | | | |
| with 34% filler | | | | |
| from Table 3) | | | | |

As can be seen, a filled polymer composition according to the invention surprisingly outperforms commercial PU based filled materials applied in railway track structures with respect to water absorption, volume resistivity and compression set. Thus, the elastomer polymers of the present invention are proven to be particularly suitable for use in railway track structures and systems.

1. An elastomeric polymer composition comprising an acrylate and the reaction product of an acetoacetylating agent and a polyol, and wherein the polyol comprises:
a) at least one dimer fatty residue selected from a dimer fatty acid residue, a dimer fatty diol residue and a dimer fatty diamine residue: and
b) at least one residue of a linear or branched C2 to C36 diacid or diol.

2. (canceled)

3. An elastomeric polymer composition to claim 1, wherein the elastomeric polymer composition does not contain isocyanate.

4. An elastomeric polymer composition of claim 1, wherein the molar ratio of the reaction product of an acetoacetylating agent and a polyol to acrylate is in a range selected from the group consisting of: from between 1:0.2 to 1:4, from between 1:0.25 to 1:3, from between 1:0.25 to 1:2.5, and from between 1:0.25 to 1:1.8.

5. An elastomeric polymer composition of claim 1, wherein the acetoacetylating agent is selected from one or more of the following: methyl acetoacetate, ethyl acetoacetate, tert-butyl acetoacetate, isopropyl acetoacetate, and isobutyl acetoacetate.

6. An elastomeric polymer composition of claim 5, wherein the reaction product of the acetoacetylating agent and the polyol comprises at most 10 wt % acetoacetylating agent.

7. An elastomeric polymer composition of claim 5, wherein the weight ratio of a) to b) in the polyol is in the range 90:10 to 30:70.

8. An elastomeric polymer composition of claim 1, wherein the dimer fatty residue content of the elastomeric polymer composition is in the range from 5 to 60% by weight.

9. An elastomeric polymer composition of claim 1, wherein the reaction product of the acetoacetylating agent and the polyol may comprisei at least 10 wt % dimer fatty residue.

10. (canceled)

11. An elastomeric polymer composition of claim 1, wherein the elastomeric polymer composition comprises an acrylate selected from one or more of a monoacrylate, a polyfunctional acrylate, an oligomeric acrylate, or derivatives thereof

12. (canceled)

13. An elastomeric polymer composition according to claim 1, comprising a filler in an amount of between 5 and 60 wt % based on the total weight of the polymer composition.

14. An elastomeric polymer composition according to claim 9, comprising one or more plasticizers.

15. (canceled)

16. (canceled)

17. (canceled)

18. A method of applying the elastomeric polymer composition of claim 1 in railway track structures, the method comprising the steps of:
i) preparing a polymer composition mixture by mixing
A) the reaction product of an acetoacetylating agent and a polyol and wherein the polyol comprises:
a) at least one dimer fatty residue selected from a dimer fatty acid residue, a dimer fatty diol residue and a dimer fatty diamine residue; and
b) at least one residue of a linear or branched C2 to C36 diacid or diol;
and
B) an acrylate;
ii) applying the polymer composition mixture to at least one or more railway track structure component; and
iii) allowing the polymer composition mixture to cure.

19. A method according to claim 18, wherein the curing of step iii) is achieved via a free radical polymerisation reaction or via a Michael addition reaction.

20. (canceled)

21. (canceled)

22. A method according to claim 18, wherein in method step ii) the polymer composition mixture is applied to three sides of the rail such that the rail is embedded on three sides by the cured polymer composition or in a body of the cured polymer composition.

23. (canceled)

24. (canceled)

25. A method of claims 18, wherein after method step i) the resulting polymer composition mixture is applied in a gap, cavity, channel, or mould.

26. (canceled)

27. (canceled)

28. (canceled)

29. (canceled)

30. (canceled)

31. (canceled)

32. The method of claim 18 wherein the acetoacetylating agent is selected from one or more of the following: methyl acetoacetate, ethyl acetoacetate, tert-butyl acetoacetate, isopropyl acetoacetate, and isobutyl acetoacetate; and the reaction productof the acetoacetylating agent and the polyol comprises at least 10 wt % dimer fatter residue.
